(19) United States
(12) Patent Application Publication
(10) Pub. No.: US 2026/0078698 A1
(43) Pub. Date: Mar. 19, 2026

(54) HEAT EXCHANGE SYSTEMS WITH FLUID INTAKE CONTROL AND ASSOCIATED METHODS

(71) Applicants: GE Avio S.r.l., Rivalta di Torino (IT); General Electric Company Polska sp. z o.o., Warsaw (PL)

(72) Inventors: Vincenzo Martina, Alpignano (IT); Roberto Maddaleno, Lanzo Torinese (IT); Aleksander Piotr Pasieczny, Warsaw (PL)

(21) Appl. No.: 19/313,334

(22) Filed: Aug. 28, 2025

(30) Foreign Application Priority Data
Sep. 13, 2024 (PL) P.449816

(51) Int. Cl. F02C 7/14; B64D 33/08

(52) U.S. Cl. CPC F02C 7/14; B64D 33/08; F05D 2220/323; F05D 2260/20; F05D 2270/303; F05D 2270/3062

(57) ABSTRACT

Heat exchange systems with fluid intake control and associated methods are disclosed. An example system includes a conduit to carry a first fluid, a heat exchanger operatively coupled to the conduit, the heat exchanger to cause the first fluid to exchange thermal energy with a second fluid, a fan positioned in a portion of the conduit to drive the first fluid past the fan, wherein the fan is electrically driven, and a valve coupled to the conduit, wherein the first fluid flows through the portion of the conduit when the valve is in a first position, and wherein the valve blocks the first fluid from flowing through the portion of the conduit when the valve is in a second position.

### RELATED APPLICATION

This patent claims the benefit of Polish Patent Application No. P.449816, which was filed on Sep. 13, 2024. Polish Patent Application No. P.449816 is hereby incorporated herein by reference in its entirety. Priority to Polish Patent Application No. P.449816 is hereby claimed.

### FIELD OF THE DISCLOSURE

This disclosure relates generally to aircraft systems and, more particularly, to heat exchange systems with fluid intake control and associated methods.

### BACKGROUND

Aircraft typically include various accessory systems supporting the operation of the aircraft and/or an engine(s) of the aircraft. For example, such accessory systems may include a lubrication system that lubricates components of the engine(s), an engine cooling system that provides cooling air to engine components, an environmental control system that provides cooled air to the cabin of the aircraft, and/or the like. As such, heat is added or removed from a fluid (e.g., oil, air, etc.) during operation of these accessory systems.

### BRIEF DESCRIPTION OF THE DRAWINGS

FIG. 1 is a side view of an example aircraft that includes a heat exchange system and a gas turbine engine.

FIG. 2 is a schematic cross-sectional view of the gas turbine engine of FIG. 1 including a heat exchange system.

FIG. 3A illustrates an example heat exchange system for the aircraft of FIG. 1 and/or the gas turbine engine of FIGS. 1-2.

FIG. 3B illustrates an isolated view of the example heat exchange system of FIG. 3A.

FIG. 4 illustrates another isolated view of the example heat exchange system of FIGS. 3A-3B.

FIG. 5 illustrates another isolated view of the example heat exchange system of FIGS. 3A, 3B, and 4.

FIG. 6 illustrates another isolated view of the example heat exchange system of FIGS. 3A, 3B, 4, and 5.

FIG. 7 illustrates another example heat exchange system for the aircraft of FIG. 1 and/or the gas turbine engine of FIGS. 1-2.

FIG. 8 illustrates an isolated view of the example heat exchange system of FIG. 7.

FIG. 9 illustrates another isolated view of the example heat exchange system of FIGS. 7 and 8.

FIG. 10 illustrates another isolated view of the example heat exchange system of FIGS. 7, 8, and 9.

FIG. 11 illustrates an isolated view of another example heat exchange system for the aircraft of FIG. 1 and/or the gas turbine engine of FIGS. 1-2.

FIG. 12A is a flowchart representative of example machine readable instructions and/or example operations that may be executed, instantiated, and/or performed by example programmable circuitry to control the example heat exchange systems of FIGS. 3A, 3B, 4, 5, 6, 7, 8, 9, 10, and/or 11.

FIG. 12B is another flowchart representative of example machine readable instructions and/or example operations that may be executed, instantiated, and/or performed by example programmable circuitry to control the example heat exchange systems of FIGS. 3A, 3B, 4, 5, 6, 7, 8, 9, 10, and/or 11.

FIG. 13 is another flowchart representative of example machine readable instructions and/or example operations that may be executed, instantiated, and/or performed by example programmable circuitry to control the example heat exchange systems of FIGS. 3A, 3B, 4, 5, 6, 7, 8, 9, 10, and/or 11.

FIG. 14 is a block diagram of an example processing platform including programmable circuitry structured to execute, instantiate, and/or perform the example machine readable instructions and/or perform the example operations of FIGS. 12A, 12B, and/or 13 to implement control circuitry of the example heat exchange systems of FIGS. 3A, 3B, 4, 5, 6, 7, 8, 9, 10, and/or 11.

In general, the same reference numbers will be used throughout the drawing(s) and accompanying written description to refer to the same or like parts. The figures are not necessarily to scale.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, “dynamic head” refers to a pressure due to a velocity of airflow (e.g., airspeed) and an air density. Specifically, the dynamic head can be calculated using Equation 1 below:

$$Q = \frac{1}{2} ρ * {v}^{2} . \qquad Equation 1$$

In Equation 1, Q corresponds to the dynamic head, ρ corresponds to the air density, and v corresponds to the velocity of the airflow. As the dynamic head is proportional to the square of airspeed and a density of the air, the dynamic head varies with altitude and temperature in addition to airspeed.

A heat exchanger associated with an aircraft (e.g., an air cooled oil cooler) can utilize movement of an engine and/or aircraft to provide airflow to the heat exchanger that can be utilized in a thermal energy exchange with another fluid. For example, as the aircraft moves, the air by which the aircraft is moving can flow into the heat exchanger for the thermal energy exchange. In some examples, the air cools another fluid (e.g., oil, air, etc.) that supports the operations of the aircraft and/or the engine. During certain operations, such as cruise, a speed of the aircraft and/or a flow rate of the air produced by the engine results in a sufficient airflow to obtain a desired thermal energy exchange (e.g., to reduce the temperature of the other fluid by a predetermined amount). However, during some operations, such as ground operations and/or takeoff operations, the airflow is too low to obtain a desired thermal energy exchange.

Examples disclosed herein provide heat exchange systems that enable production of airflow at a desired rate for an associated thermal energy exchange regardless of the operational state of the aircraft and/or the engine. An example heat exchange system includes a conduit including branch sections (e.g., a first branch section, a second branch section) and a trunk section in which a heat exchanger (e.g., a finned tube heat exchanger, a shell and tube heat exchanger, a plate heat exchanger, etc.) is positioned. The heat exchanger enables thermal energy (e.g., heat) to be exchanged between a first fluid that flows through the conduit and a second fluid that supports the operations of the aircraft. For example, the first fluid can be air and the second fluid can be oil as in an air cooled oil cooler. The example heat exchange system includes a flow producing device (e.g., a fan, an ejector, etc.) positioned in the first branch section. The example heat exchange system also includes a valve (e.g., a door pivotable about a hinge) movable between a first position in which the valve blocks airflow through the second branch section and a second position in which the valve blocks airflow through the first branch section. In some examples, during operations in which a flow rate of the first fluid in the conduit does not satisfy (e.g., is less than) a flow target and/or a temperature of the second fluid output by the heat exchanger does not satisfy (e.g., is greater than) a temperature target, the valve moves to the first position and the flow producing device is activated to increase a flow rate of the fluid in the conduit. As a result, a heat transfer rate between the first fluid and the second fluid in the heat exchanger increases. That is, the flow producing device, when active, causes an increased flow rate through the heat exchanger, which is independent of the available dynamic head encountered at an inlet of the conduit. As such, higher flow and higher flow speed increases heat exchange rate from the second fluid to the first fluid via the heat exchanger.

In some examples, during operations in which the flow rate of the first fluid in the conduit satisfies (e.g., is greater than, is greater than or equal to, is within a range of) the flow target and/or the temperature of the second fluid output by the heat exchanger satisfies (e.g., is less than, is less than or equal to, is within a range of) the temperature target, the valve moves to the second position and the flow producing device is deactivated. Blocking the first fluid from flowing through the first branch section can prevent the first fluid from encountering drag through contact with the flow producing device. In some examples, deactivating the flow producing device saves power, which can then be utilized to support other operations associated with the aircraft.

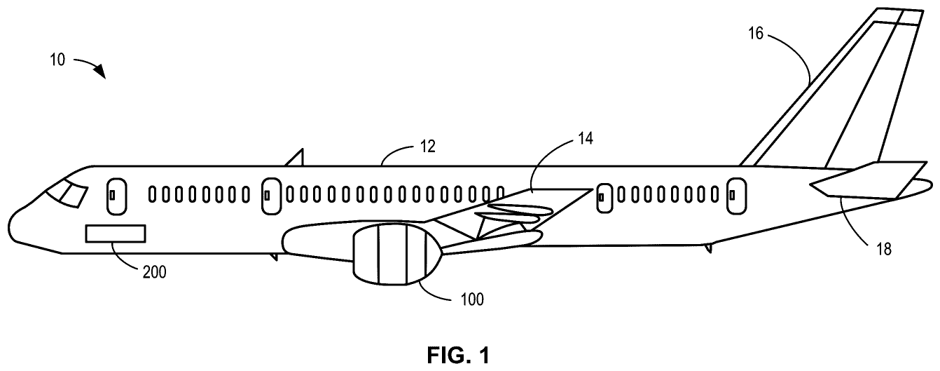

Referring now to the drawings, FIG. 1 is a side view of one example of an aircraft 10. As shown, the aircraft 10 includes a fuselage 12 and a pair of wings 14 (one is shown) extending outward from the fuselage 12. In the illustrated example, a gas turbine engine 100, which is also referred to herein as a “turbofan engine 100,” is supported on each wing 14 to propel the aircraft through the air during flight. Additionally, as shown, the aircraft 10 includes a vertical stabilizer 16 and a pair of horizontal stabilizers 18 (one is shown). However, in alternative examples, the aircraft 10 may include any other suitable configuration, such as any other suitable number or type of engines.

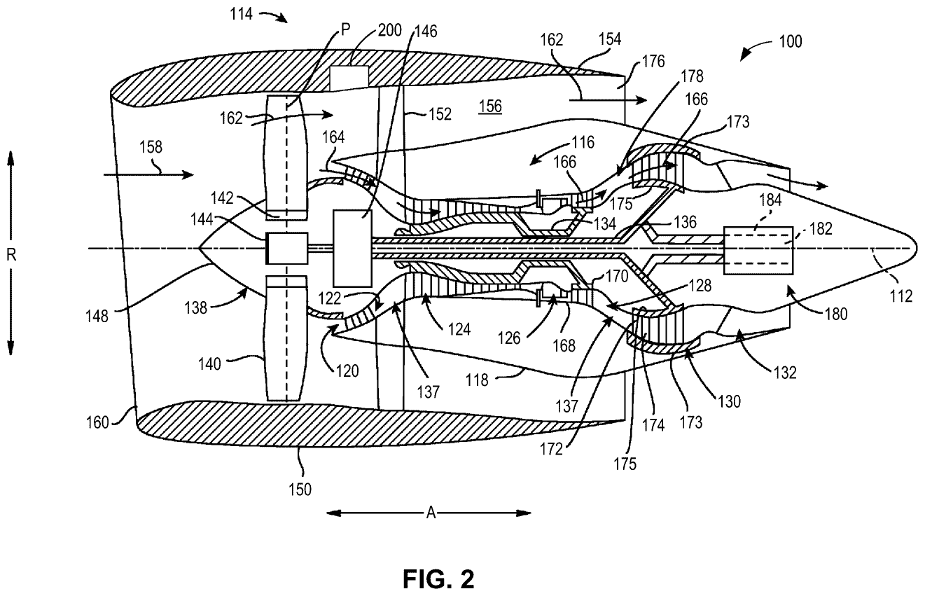

In the illustrated example of FIG. 1, the aircraft 10 may include a heat exchange system 200 for transferring heat to and/or from fluids supporting the operation of the aircraft 10. More specifically, the aircraft 10 may include one or more accessory systems configured to support the operation of the aircraft 10. For example, in some examples, such accessory systems include a lubrication system that lubricates components of the engines 100, a cooling system that provides cooling air to components of the engines 100, an environmental control system that provides cooled air to the cabin of the aircraft 10, and/or the like. In such examples, the heat exchange system 200 is configured to transfer heat to and/or from one or more fluids supporting the operation of the aircraft 10 (e.g., the oil of the lubrication system, the air of the cooling system and/or the environmental control system, the fuel supplied to the engines 100, etc.). However, in alternative examples, the heat exchange system 200 may be configured to transfer heat to and/or from any other suitable fluids supporting the operation of the aircraft 10. In some examples, the heat exchange system 200 cools electronic devices, such as electronic devices utilized for power generation (e.g., a battery, a fuel cell, etc.). In the example of FIG. 1, the heat exchange system 200 is positioned in (e.g., embedded in) the fuselage 12. Additionally or alternatively, the heat exchange system 200 can be positioned in the engines 100, as discussed further in association with FIG. 2, in the wings 14, and/or in pylons that couple the engines 100 to the wings 14.

FIG. 2 is a schematic cross-sectional view of one example of the gas turbine engine 100 of FIG. 1. More particularly, for the example of FIG. 2, the gas turbine engine 100 is a high-bypass turbofan jet engine, referred to herein as “turbofan engine 100.” As shown in FIG. 2, the turbofan engine 100 defines an axial direction A (extending parallel to a longitudinal axis 112 provided for reference), a radial direction R, and a circumferential direction (i.e., a direction extending about the axial direction A; not depicted). In general, the turbofan engine 100 includes a fan section 114 and a core turbine engine 116 disposed downstream from the fan section 114.

The example core turbine engine 116 depicted generally includes a substantially tubular outer casing 118 that defines an annular inlet 120. The outer casing 118 encases, in serial flow relationship, a compressor section including a booster or low pressure (LP) compressor 122 and a high pressure (HP) compressor 124; a combustion section 126; a turbine section including a high pressure (HP) turbine 128 and a low pressure (LP) turbine 130; and a jet exhaust nozzle section 132. The compressor section, combustion section 126, and turbine section together define a core air flow path 137 extending from the annular inlet 120 through the LP compressor 122, HP compressor 124, combustion section 126, HP turbine section 128, LP turbine section 130 and jet exhaust nozzle section 132. A high pressure (HP) shaft or spool 134 drivingly connects the HP turbine 128 to the HP compressor 124. A low pressure (LP) shaft or spool 136 drivingly connects the LP turbine 130 to the LP compressor 122.

For the example depicted in FIG. 2, the fan section 114 includes a variable pitch fan 138 having a plurality of fan blades 140 coupled to a disk 142 in a spaced apart manner. As depicted, the fan blades 140 extend outwardly from disk 142 generally along the radial direction R. Each fan blade 140 is rotatable relative to the disk 142 about a pitch axis P by virtue of the fan blades 140 being operatively coupled to a suitable actuation member 144 configured to collectively vary the pitch of the fan blades 140 in unison. The fan blades 140, disk 142, and actuation member 144 are together rotatable about the longitudinal axis 112 by LP shaft 136 across a power gearbox 146. The power gearbox 146 includes a plurality of gears for stepping down the rotational speed of the LP shaft 136 to a more efficient rotational fan speed.

Referring still to the example of FIG. 2, the disk 142 is covered by rotatable front nacelle 148 aerodynamically contoured to promote an airflow through the plurality of fan blades 140. Additionally, the example fan section 114 includes an annular fan casing or outer nacelle 150 that circumferentially surrounds the fan 138 and/or at least a portion of the core turbine engine 116. It should be appreciated that for the example depicted, the nacelle 150 is supported relative to the core turbine engine 116 by a plurality of circumferentially-spaced outlet guide vanes 152. Moreover, a downstream section 154 of the nacelle 150 extends over an outer portion of the core turbine engine 116 so as to define a bypass airflow passage 156 therebetween.

During operation of the turbofan engine 100, a volume of air 158 enters the turbofan engine 100 through an associated inlet 160 of the nacelle 150 and/or fan section 114. As the volume of air 158 passes across the fan blades 140, a first portion of the air 158 as indicated by arrows 162 is directed or routed into the bypass airflow passage 156 and a second portion of the air 158 as indicated by arrow 164 is directed or routed into the LP compressor 122. The ratio between the first portion of air 158 at arrows 162 and the second portion of air 158 at arrows 164 is commonly known as a bypass ratio. The temperature and pressure of the second portion of air 158 at the arrows 164 are then increased as it is routed through the high pressure (HP) compressor 124 and into the combustion section 126, where it is mixed with fuel and burned to provide combustion gases 166.

The combustion gases 166 are routed through the HP turbine 128 where a portion of thermal and/or kinetic energy from the combustion gases 166 is extracted via sequential stages of HP turbine stator vanes 168 that are coupled to the outer casing 118 and HP turbine rotor blades 170 that are coupled to the HP shaft or spool 134, thus causing the HP shaft or spool 134 to rotate, which supports operation of the HP compressor 124. The combustion gases 166 are then routed through the LP turbine 130 where a second portion of thermal and kinetic energy is extracted from the combustion gases 166 via sequential stages of a first plurality of LP turbine rotor blades 172 that are coupled to an outer drum 173, and a second plurality of turbine rotor blades 174 that are coupled to an inner drum 175. The first plurality of turbine rotor blades 172 and second plurality of turbine rotor blades 174 are alternatingly spaced and rotatable with one another through a gearbox (not shown) to together drive the LP shaft or spool 136, thus causing the LP shaft or spool 136 to rotate. Such rotation of the LP shaft or spool 136 supports operation of the LP compressor 122 and/or rotation of the fan 138.

The combustion gases 166 are subsequently routed through the jet exhaust nozzle section 132 of the core turbine engine 116 to provide propulsive thrust. Simultaneously, the pressure of the first portion of air 162 is substantially increased as the first portion of air 162 is routed through the bypass airflow passage 156 before it is exhausted from a fan nozzle exhaust section 176 of the turbofan engine 100, also providing propulsive thrust. The HP turbine 128, the LP turbine 130, and the jet exhaust nozzle section 132 at least partially define a hot gas path 178 for routing the combustion gases 166 through the core turbine engine 116.

Additionally, the example turbofan engine 100 depicted in the example of FIG. 2 includes an electric machine 180 rotatable with the fan 138. Specifically, for the example depicted, the electric machine 180 is co-axially mounted to and rotatable with the LP shaft 136 (the LP shaft 136 also rotating the fan 138 through, for the example depicted, the power gearbox 146). As used herein, “co-axially” refers to the axes of the electric machine 180 and the LP shaft 136 being aligned. It should be appreciated, however, that in other examples, an axis of the electric machine 180 may be offset radially from the axis of the LP shaft 136 and further may be oblique to the axis of the LP shaft 136, such that the electric machine 180 may be positioned at any suitable location at least partially inward of the core air flow path 137.

The electric machine 180 includes a rotor 182 (or rather, multiple rotors, as will be explained in more detail, below) and a stator 184. It will be appreciated that, in certain examples, the turbofan engine 100 may be integrated into a propulsion system. With such an example, the electric machine 180 may be electrically connected, or connectable, to one or more electric propulsion devices of the propulsion system (such as one or more electric fans), one or more power storage devices, etc.

As mentioned above, the aircraft 10 of FIG. 1 may include a heat exchange system 200 for transferring heat between fluids supporting the operation of the aircraft 10. In this respect, the heat exchange system 200 may be positioned within the engine 100. For example, as shown in FIG. 2, the heat exchange system 200 is positioned within the nacelle 110 of the engine 100. However, in alternative examples, the heat exchange system 200 may be positioned at any other suitable location within the engine 100, such as in the outer casing 118.

It should be appreciated, however, that the example turbofan engine 100 depicted in FIG. 2 is by way of example only, and that in other examples, the turbofan engine 100 may have any other suitable configuration. For example, in other examples, the turbofan engine 100 may instead be configured as any other suitable turbomachine including, e.g., any other suitable number of shafts or spools, and excluding, e.g., the power gearbox 146 and/or fan 138, etc. Accordingly, it will be appreciated that in other examples, the turbofan engine 100 may instead be configured as, e.g., a turbojet engine, a turboshaft engine, a turboprop engine, a hybrid-electric propulsor including one or more electric motors, etc.

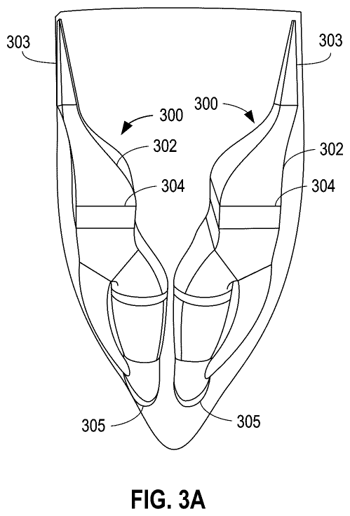

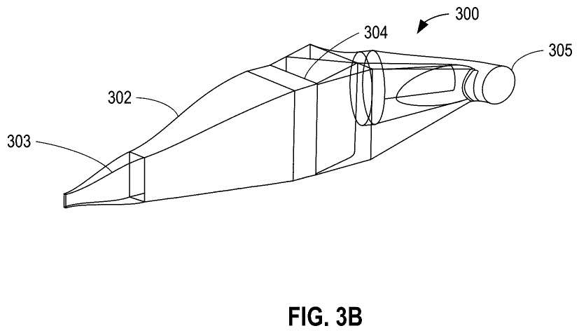

FIG. 3A illustrates an example heat exchange system 300 (e.g., an aircraft system, an example implementation of the heat exchange system 200 of FIGS. 1 and/or 2) in accordance with the teachings disclosed herein. Specifically, in the illustrated example of FIG. 3A, there are two instances of the example heat exchange system 300. FIG. 3B is an isolated view of one instance of the heat exchange system 300 of FIG. 3A. In the illustrated example of FIGS. 3A-3B, the heat exchange system 300 includes a conduit 302 that has an inlet 303 and an outlet 305 fluidly coupled to an external fluid flow passage (e.g., the bypass airflow passage 156 of FIG. 2, an airflow passage proximate the aircraft 10) in which a first fluid (e.g., air) flows. The heat exchange system 200 includes a heat exchanger 304 positioned in and/or operatively coupled to the conduit 302 between the inlet 303 and the outlet 305. Accordingly, the conduit 302 directs the first fluid to the heat exchanger 304 where the first fluid exchanges thermal energy (e.g., heat) with a second fluid (e.g., oil) to support operations of the aircraft 10 of FIG. 1 and/or the engine 100 of FIGS. 1-2.

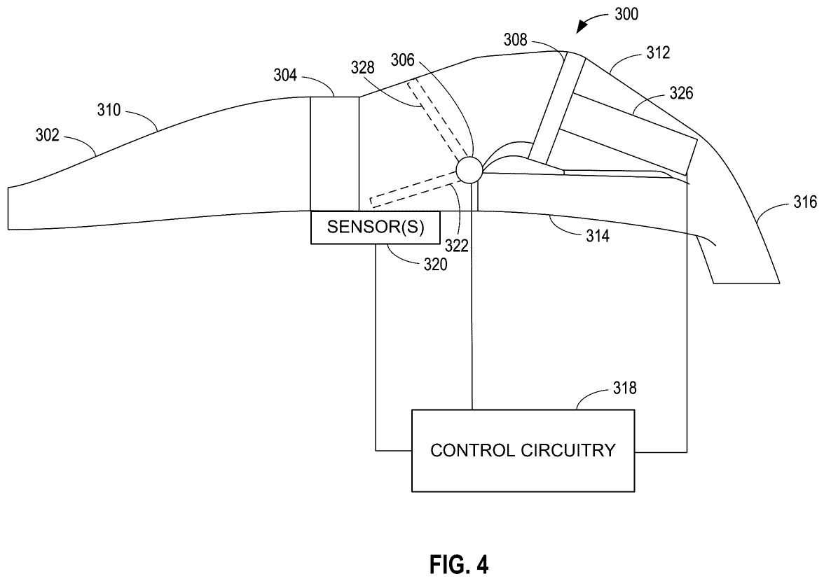

FIGS. 4, 5, and 6 illustrate isolated views of the example heat exchange system 300 of FIGS. 3A-3B. The heat exchange system 300 includes the conduit 302, the heat exchanger 304, a valve 306 (e.g., a door pivotable about a hinge), and a fan 308 (e.g., a suction fan). The conduit 302 includes a first portion 310 (e.g., an upstream trunk section), a second portion 312 (e.g., a first branch section), a third portion 314 (e.g., a second branch section), and a fourth portion 316 (e.g., a downstream trunk section). The inlet 303 is defined at an end of the first portion 310, and the outlet 305 is defined at an end of the fourth portion 316. Accordingly, the first portion 310 and the fourth portion 316 of the conduit 302 are fluidly coupled to the external fluid flow passage (e.g., the bypass airflow passage 156 of FIG. 2, an airflow passage proximate the aircraft 10) in which a first fluid (e.g., air) flows. That is, the first fluid enters the first portion 310 of the conduit 302 and exchanges thermal energy with the second fluid via the heat exchanger 304 before the fourth portion 316 of the conduit 302 directs the first fluid to the external fluid flow passage or another fluid flow passage. The second portion 312 and the third portion 314 intersect at the first portion 310 and the fourth portion 316. More specifically, the second portion 312 and the third portion 314 intersect (e.g., merge) (i) downstream of the heat exchanger 304 and upstream of the fan 308 and (ii) downstream of the fan 308.

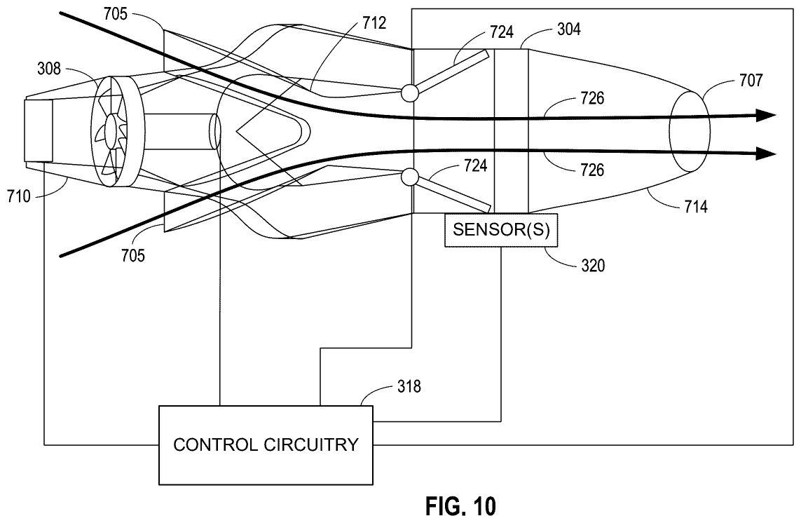

The heat exchange system 300 also includes control circuitry 318 communicatively coupled to one or more sensors 320. The control circuitry 318 may be instantiated (e.g., creating an instance of, bring into being for any length of time, materialize, implement, etc.) by programmable circuitry such as a Central Processor Unit (CPU) executing first instructions. Additionally or alternatively, the control circuitry 318 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the control circuitry 318 may, thus, be instantiated at the same or different times. Some or all of the control circuitry 318 may be instantiated, for example, in one or more threads executing concurrently on hardware and/or in series on hardware. Moreover, in some examples, some or all of the control circuitry 318 may be implemented by microprocessor circuitry executing instructions and/or FPGA circuitry performing operations to implement one or more virtual machines and/or containers. In some examples, the control circuitry 318 is instantiated by programmable circuitry executing control instructions and/or configured to perform operations such as those represented by the flowchart(s) of FIGS. 10 and/or 11.

The sensors 320 measure one or more properties of the first fluid and/or the second fluid. For example, the sensors 320 can measure a flow rate of the first fluid in the conduit 302, a pressure of the first fluid, and/or a temperature of the first fluid. Further, the sensors 320 can measure a temperature of the second fluid before flowing through the heat exchanger 304 and/or a temperature of the second fluid after flowing through the heat exchanger 304. The control circuitry 318 determines a target temperature (e.g., a temperature threshold) for the second fluid. For example, the target temperature can be based on a threshold temperature associated with maintaining a desired property (e.g., a viscosity, a temperature, etc.) of the second fluid for supporting the operations of the aircraft 10 of FIG. 1 and/or the engine 100 of FIGS. 1-2. The control circuitry 318 can compare the temperature of the second fluid after flowing through the heat exchanger 304 to the target temperature. In some examples, the control circuitry 318 determines a dynamic head threshold for the first fluid that enables the second fluid to satisfy (e.g., be less than, be less than or equal to, be within a range of or approximately equivalent to) the target temperature after flowing through the heat exchanger 304. For example, the dynamic head threshold can be a flow rate threshold for the first fluid in the conduit 302.

The control circuitry 318 controls the valve 306 and the fan 308 based on the temperature of the second fluid produced by the heat exchanger 304, the dynamic head of the first fluid in the conduit 302, and/or an operational state of the aircraft 10 (FIG. 1) and/or the engine 100 (FIGS. 1-2). In some examples, when (i) the temperature of the second fluid does not satisfy (e.g., is greater than, is greater than or equal to) the target temperature, (ii) the dynamic head of the first fluid does not satisfy (e.g., is less than, is less than or equal to) the dynamic head threshold, and/or (iii) operations being performed by the aircraft 10 and/or the engine 100 are associated with a low dynamic head of the first fluid in the external fluid flow passage (e.g., during ground operations, during takeoff, etc.), the control circuitry 318 determines that the flow rate of the first fluid in the conduit 302 is insufficient (e.g., too low, less than a threshold flow rate associated with the target temperature) to cool the second fluid. For example, during ground operations associated with the aircraft 10, the flow rate of the air in the bypass airflow passage 156 can be too low to cool the oil that is supporting the operations of the engine 100.

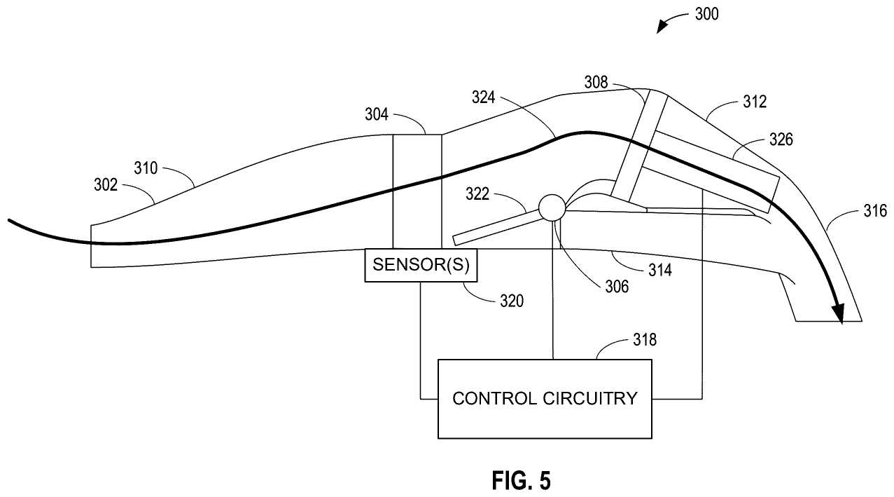

To increase the flow rate of the first fluid in the conduit 302, the control circuitry 318 causes the valve 306 to be in (e.g., move to or remain in) a first position 322 (FIGS. 4 and 5) and activates the fan 308 (e.g., causes blades of the fan 308 to rotate for suction of air through the second portion 312 of the conduit 302). The fan 308 is an electrically driven fan that includes a motor 326. As such, the control circuitry 318 causes a drive signal to be delivered to the motor 326 to activate the fan 308. When the valve 306 is in the first position 322, the valve 306 directs the first fluid into the second portion 312 of the conduit 302 and blocks the first fluid from flowing into the third portion 314 of the conduit 302. Specifically, the first fluid flows in a first flow path 324 through the conduit 302, as shown in FIG. 4. As such, when the temperature of the second fluid does not satisfy (e.g., is greater than, is greater than or equal to) the target temperature, the control circuitry 318 causes electrical power to be delivered to the motor 326, which drives the fan 308. In turn, the rotation of the fan 308 increases a flow rate of the first fluid through the conduit 302.

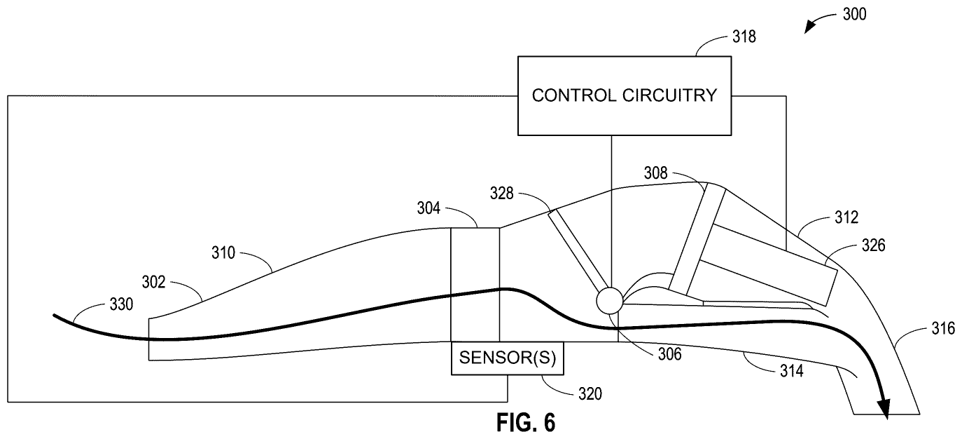

In some examples, when (i) the temperature of the second fluid satisfies the target temperature after flowing through the heat exchanger 304, (ii) the dynamic head of the first fluid satisfies (e.g., is greater than or equal to, is greater than) the dynamic head threshold, and/or (iii) operations being performed by the aircraft 10 and/or the engine 100 are associated with a high flow rate in the external fluid flow passage (e.g., during cruise operations, etc.), the control circuitry 318 determines that the flow rate of the first fluid in the conduit 302 is sufficient (e.g., is greater than or equal to the threshold flow rate associated with the target temperature) to cool the second fluid without utilization of the fan 308. In some such examples, the control circuitry 318 causes the fan 308 to stop rotating (e.g., stops delivering power to the electric motor 326, deactivates the fan 308) and moves the valve 306 to a second position 328 (FIGS. 4 and 6). For example, the valve 306 can be implemented by a door that is pivotable about a hinge to move between the first position 322 and the second position 328. Moving the valve to the second position 328 prevents the fan 308 from encountering windmilling and/or inadvertent rotation, which would otherwise increase noise and/or damage the fan 308 (e.g., the electric motor 326 of the fan 308).

In the second position 328, the valve 306 directs the first fluid into the third portion 314 of the conduit 302 and blocks the first fluid from flowing through the second portion 312 of the conduit 302. As such, the first fluid flows in a second flow path 330 through the conduit 302, as shown in FIG. 6. Moving the valve 306 to the second position 328 and blocking the first fluid from flowing through the second portion 312 of the conduit 302, prevents the first fluid from encountering drag that would otherwise result from aerodynamically encountering (e.g., contacting, flowing past or proximate to) the fan 308 when the fan 308 is deactivated. As such, the control circuitry 318 enables the fan 308 to help increase the flow rate of the first fluid when desired while saving power and avoiding affecting the flow rate of the first fluid when the dynamic head of the first fluid in the external flow passage is sufficient to cool the second fluid.

In some examples, the control circuitry 318 modulates a rotational velocity of the fan 308 and/or a position of the valve 306 based on the temperature of the second fluid, the dynamic head of the first fluid, and/or the operations being performed by the aircraft 10 and/or the engine 100. For example, the control circuitry 318 can move the valve 306 to a position between the first position 322 and the second position 328 to enable the first fluid to flow through both the second portion 312 and the third portion 314 of the conduit 302 based on the temperature of the second fluid, the dynamic head of the first fluid, and/or the operations being performed by the aircraft 10 and/or the engine 100. Further, the control circuitry 318 can activate the fan 308 to cause the fan 308 to increase a flow rate of the first fluid. For example, the control circuitry 318 can cause the fan 308 to operate at a reduced speed (e.g., deliver a lower power drive signal to the motor 326, a one-quarter (25%) speed, a one-half (50%) speed, a three-quarter (75%) speed, etc.) to reduce power consumption by the fan 308 and enable an aerodynamic stability of the flow of the first fluid in the second portion 312 of the conduit 302 to be maintained. The speed at which the control circuitry 318 causes the fan 308 to operate can be a function of flight operating altitude, temperature target, flow rate, etc. The control circuitry 318 can increase a rotational velocity of the fan 308 and/or move the valve 306 towards the first position 322 with an increase in the temperature of the second fluid (e.g., when the temperature is greater than a temperature threshold) and/or a decrease in the dynamic head of the first fluid (e.g., when the dynamic head of the first fluid is less than a dynamic head threshold). In some examples, the control circuitry 318 can reduces the speed of the fan 308 and/or moves the valve 306 towards the second position 328 over time (e.g., in defined increments, at a defined rate) as the operations being performed by the aircraft 10 and/or the engine 100 transition from first operations that are associated with a low dynamic head of the first fluid in the external fluid flow passage (e.g., during ground operations, during takeoff, etc.) to second operations that are associated with a sufficient dynamic head of the first fluid (e.g., cruise operations).

In some examples, to determine the modulated position and/or rotational velocity of the valve 306 and the fan 308, the control circuitry 318 maps (i) the temperature of the second fluid after flowing through the heat exchanger 304 and/or a flow rate of the first fluid in the first portion of the conduit 302 to (ii) a particular position for the valve 306 and/or a particular speed for the fan 308.

In some examples, the heat exchange system 300 starts operations of the aircraft 10 and/or the engine 100 with the valve 306 in the second position 328 and the fan 308 deactivated. In such examples, when the dynamic head of the first fluid does not satisfy (e.g., is less than, is less than or equal to) the dynamic head threshold and/or the temperature of the second fluid after flowing through the heat exchanger 304 does not satisfy (e.g., is greater than, is greater than or equal to) the temperature threshold, the control circuitry 318 causes the fan 308 to rotate at a first modulated speed (e.g., a first speed that is greater than zero and less than a maximum speed) and causes the valve 306 to move a predetermined amount (e.g., a predetermined rotation, a predetermined distance) from the second position 328 towards the first position 322 (e.g., moves the valve 306 to a first modulated position). That is, the control circuitry 318 causes a stepped increase in the speed of the fan 308 and an opening into the second portion 312 of the conduit 302. In some examples, the control circuitry 318 waits a predetermined period (e.g., 5 seconds, 10 seconds, etc.) before again identifying the dynamic head of the first fluid and/or the temperature of the second fluid after flowing through the heat exchanger 304. When the dynamic head of the first fluid again does not satisfy the dynamic head threshold and/or the temperature of the second fluid after flowing through the heat exchanger 304 again does not satisfy the temperature threshold after the predetermined period, the control circuitry 318 causes another stepped increase in the speed of the fan 308 and/or the opening into the second portion 312 of the conduit 302 provided by the valve 306. The stepped increases can continue until the valve 306 moves to the first position 322 and the fan 308 operates at a maximum rotational velocity.

After one or more stepped increases have been performed, when the dynamic head of the first fluid satisfies the dynamic head threshold and/or the temperature of the second fluid after flowing through the heat exchanger 304 satisfies the temperature threshold, the control circuitry 318 can cause a stepped decrease in the position of the valve 306 and/or the speed of the fan 308. That is, the control circuitry 318 can move the valve 306 towards the second position 328 and reduce a speed of the fan 308. Similar to the stepped increases, the stepped decreases can continue until the valve 306 is in the second position 328 and the fan 308 is deactivated.

In some examples, to reduce the flow rate of the first fluid in the conduit 302, the control circuitry 318 causes the fan 308 to rotate in an opposite direction relative to that which increases the flow rate of the first fluid (e.g., when the dynamic head of the first fluid does not satisfy a dynamic head threshold). That is, blades of the fan 308 can be designed to move the first fluid towards the fourth portion 316 of the conduit 302 when the blades rotate in a first direction (e.g., clockwise). When the blades of the fan 308 rotate in a second direction (e.g., counterclockwise) opposite the first direction, the fan 308 causes turbulence in the flow of the first fluid in the conduit 302. As a result, the rotation of the fan 308 in the second direction reduces a flow rate of the first fluid in the conduit 302, which reduces a rate at which the first fluid absorbs heat from the second fluid in the heat exchanger 304. Thus, the control circuitry 318 can cause the fan 308 to rotate in the second direction when a temperature of the second fluid does not satisfy (e.g., is less than, is less than or equal to) a minimum temperature threshold (e.g., a temperature within a range of a freezing point temperature of the second fluid).

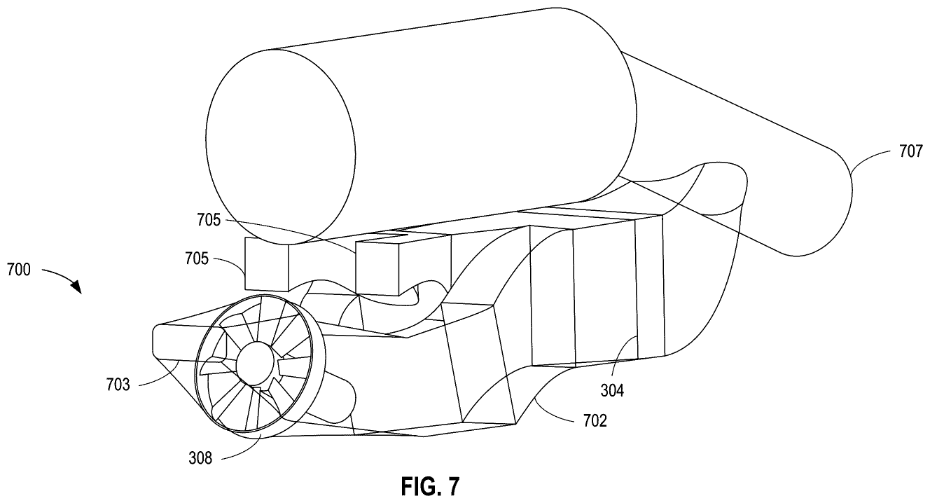

FIG. 7 illustrates another example heat exchange system 700 (e.g., an aircraft system, an example implementation of the heat exchange system 200 of FIGS. 1 and/or 2) in accordance with the teachings disclosed herein. The heat exchange system 700 includes a conduit 702 that has a first inlet 703, second inlets 705 (one of which is not shown in the view of FIG. 7), and an outlet 707 fluidly coupled to an external fluid flow passage (e.g., the bypass airflow passage 156 of FIG. 2, an airflow passage proximate the aircraft 10) in which a first fluid (e.g., air) flows. The heat exchange system 700 includes the heat exchanger 304 and the fan 308 positioned in and/or operatively coupled to the conduit 702. Accordingly, the conduit 702 directs the first fluid to the heat exchanger 304 where the first fluid exchanges thermal energy (e.g., heat) with a second fluid (e.g., oil) to support operations of the aircraft 10 of FIG. 1 and/or the engine 100 of FIGS. 1-2. Similar to the heat exchange system 300 of FIGS. 3A-6, the fan 308 can increase the dynamic head of the first fluid during certain operations to improve the thermal energy exchange between the first fluid and the second fluid, as discussed in further detail below.

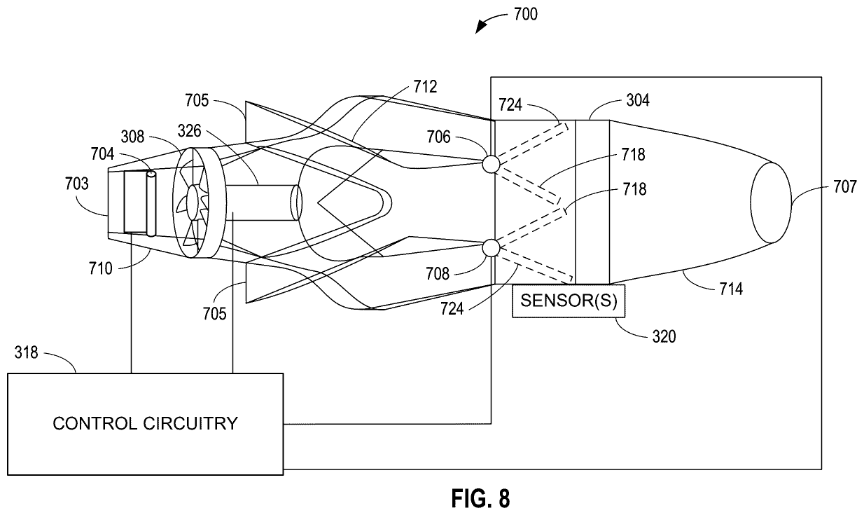

FIGS. 8, 9, and 10 illustrate an isolated view of the example heat exchange system 700 of FIG. 7. In addition to the conduit 702, the heat exchanger 304, and the fan 308, the heat exchange system 700 includes a first valve 704 (e.g., a retractable door), a second valve 706 (e.g., a door pivotable about a hinge), a third valve 708 (e.g., a door pivotable about a hinge), the control circuitry 318, and the sensors 320. The conduit 702 includes a first portion 710 (e.g., a first upstream, branch section), a second portion 712 (e.g., a second upstream, branch section), and a third portion 714 (e.g., a downstream, trunk section). The first inlet 703 is positioned at an end of the first portion 710 of the conduit 702. The second inlets 705 are positioned at an end of the second portion 712 of the conduit 702. The outlet 707 is positioned at an end of the third portion 714 of the conduit 702 and directs the first fluid to the external fluid flow passage or another fluid flow passage after the first fluid flows through the heat exchanger 304 and exchanges thermal energy with the second fluid.

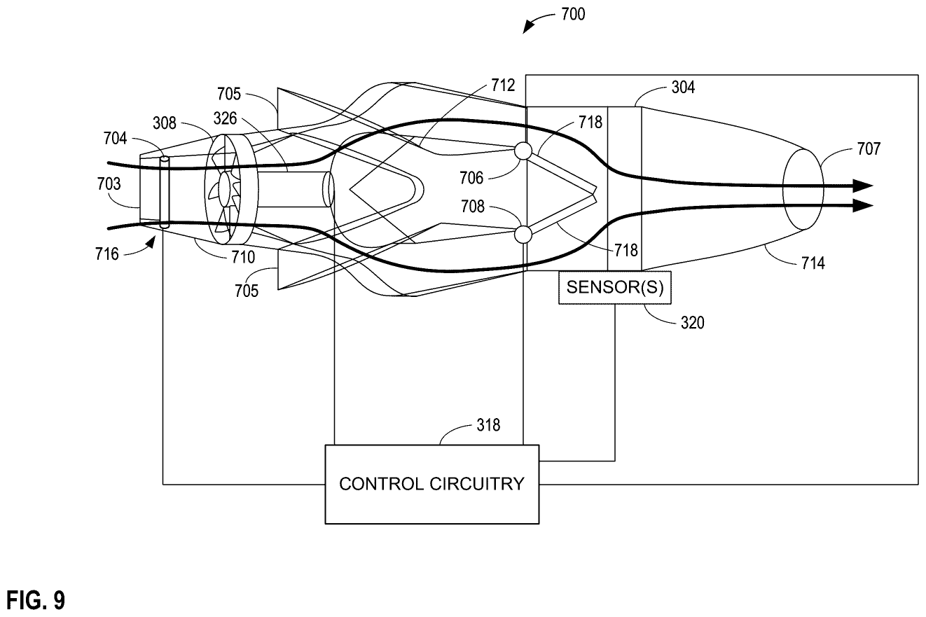

In the heat exchange system 700, when (i) the temperature of the second fluid does not satisfy (e.g., is greater than, is greater than or equal to) the target temperature, (ii) the dynamic head of the first fluid does not satisfy (e.g., is less than, is less than or equal to) the dynamic head threshold, and/or (iii) operations being performed by the aircraft 10 and/or the engine 100 are associated with a low dynamic head of the first fluid in the external fluid flow passage (e.g., during ground operations, during takeoff, etc.), the control circuitry 318 causes the first valve 704 to move to an open position 716 (FIG. 9) and causes the motor 326 to rotate the fan 308. Additionally, the control circuitry 318 causes the second valve 706 and the third valve 708 to move to first positions 718 (FIGS. 8 and 9) in which the second valve 706 and the third valve 708 direct the first fluid from the first portion 710 of the conduit 702 towards the heat exchanger 304 and block the first fluid from the second portion 712 of the conduit 702 flowing towards the heat exchanger 304. As a result, the first fluid follows a first flow path 720 through the conduit 702, as shown in FIG. 9.

In some examples, when (i) the temperature of the second fluid satisfies the target temperature after flowing through the heat exchanger 304, (ii) the dynamic head of the first fluid satisfies (e.g., is greater than or equal to, is greater than) the dynamic head threshold, and/or (iii) operations being performed by the aircraft 10 and/or the engine 100 are associated with a high flow rate in the external fluid flow passage (e.g., during cruise operations, etc.), the control circuitry 318 causes the first valve 704 to move to a closed position 722 (FIG. 10) and causes the fan 308 to stop rotating (e.g., stops delivering power to the electric motor 326, deactivates the fan 308). Additionally, the control circuitry 318 causes the second valve 706 and the third valve 708 to move to second positions 724 (FIGS. 8 and 10) in which the second valve 706 and the third valve 708 direct the first fluid from the second portion 712 of the conduit 702 towards the heat exchanger 304. As a result, the first fluid follows a second flow path 726 through the conduit 702, as shown in FIG. 10.

In some examples, the control circuitry 318 causes the first valve 704 to move to a modulated position (e.g., an intermediate position that is between the open position 716 (e.g., a fully open position) and the closed position 722 (e.g., a fully closed position)). Accordingly, the control circuitry 318 can move the first valve 704 to a partially open position based on a temperature of the first fluid upstream of the heat exchanger 304, a dynamic head of the first fluid and/or the second fluid, a temperature of the second fluid after flowing through the heat exchanger 304, and/or operations being performed by the aircraft 10 and/or the engine 100. Similarly, the control circuitry 318 can cause the second valve 706 and the third valve 708 to move to modulated positions between the first positions 718 and the second positions 724 based on the temperature of the first fluid upstream of the heat exchanger 304, the dynamic head of the first fluid and/or the second fluid, the temperature of the second fluid after flowing through the heat exchanger 304, and/or the operations being performed by the aircraft 10 and/or the engine 100. Additionally, the control circuitry 318 can modulate the speed of the fan 308 based on the temperature of the first fluid upstream of the heat exchanger 304, the dynamic head of the first fluid and/or the second fluid, the temperature of the second fluid after flowing through the heat exchanger 304, and/or the operations being performed by the aircraft 10 and/or the engine 100. In some examples, the control circuitry 318 causes adjustments to the first valve 704, the second valve 706, the third valve 708, and the fan 308 to occur in stepped increments (e.g., stepped increases or decreases in a cross-sectional opening defined by the first valve 704, stepped increases or decreases in a rotational velocity of the fan 308, stepped movements of the second valve 706 and the third valve 708 towards the first positions 718 or towards the second positions 724), similar to the stepped increases and stepped decreases discussed above in association with the heat exchange system 300 of FIGS. 3A-6.

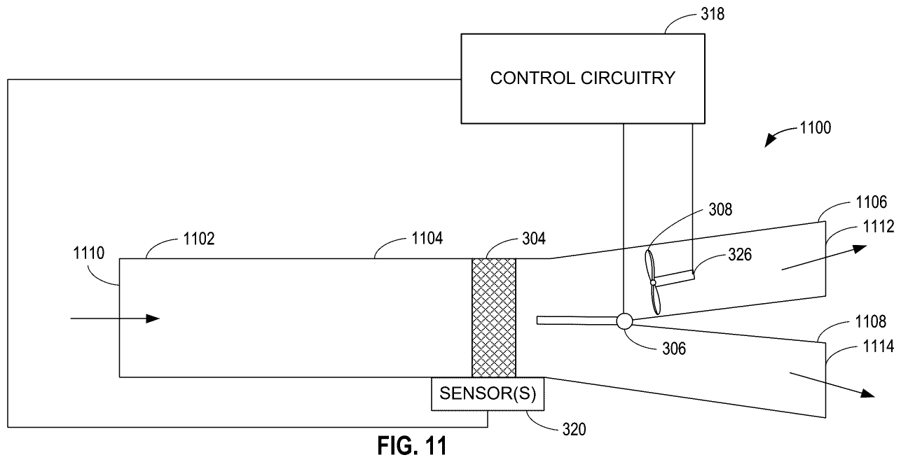

FIG. 11 illustrates another example heat exchange system 1100 (e.g., an aircraft system, another example implementation of the heat exchange system 200 of FIGS. 1 and/or 2) in accordance with the teachings disclosed herein. The heat exchange system 1100 includes a conduit 1102, the heat exchanger 304, the valve 306, the fan 308, the control circuitry 318, and the sensors 320. The conduit 1102 includes a first portion 1104 (e.g., a trunk section, the first portion 310 of the conduit 302 of FIGS. 3A-3B), a second portion 1106 (e.g., a first branch section, the second portion 312 of the conduit 302 of FIGS. 3A-3B), and a third portion 1108 (e.g., a second branch section, the third portion 314 of the conduit 302 of FIGS. 3A-3B). An inlet 1110 of the first portion 1104 is fluidly coupled to an external fluid flow passage (e.g., the bypass airflow passage 156 of FIG. 2, an airflow passage proximate the aircraft 10) in which a first fluid (e.g., air) flows. Similarly, an outlet 1112 of the second portion 1106 and/or an outlet 1114 of the third portion 1108 can be fluidly coupled to the external fluid flow passage or another fluid flow passage. Accordingly, the conduit 1102 directs the first fluid to the heat exchanger 304 where the first fluid exchanges thermal energy (e.g., heat) with a second fluid (e.g., oil) to support operations of the aircraft 10 of FIG. 1 and/or the engine 100 of FIGS. 1-2 before returning to the external fluid flow passage or flowing to another fluid flow passage.

In the illustrated example of FIG. 11, the control circuitry 318 controls the valve 306 and the fan 308 based on measurements from the sensors 320 and/or operations being performed by the aircraft 10 of FIG. 1 and/or the engine 100 of FIGS. 1-2. As such, the heat exchange system 1100 of FIG. 11 is similar to the heat exchange system 300 of FIGS. 3A-6 except that the heat exchange system 1100 of FIG. 11 does not include a downstream trunk section (e.g., the fourth portion 316 of the conduit 302 (FIGS. 4-6)) to connect downstream ends of the second portion 1106 and the third portion 1108 of the conduit 1102.

In some examples, a heat exchange system (e.g., the heat exchange system 300 of FIGS. 3A-6, the heat exchange system 700 of FIGS. 7-10, the heat exchange system 1100 of FIG. 11) includes means for carrying a first fluid. For example, the means for carrying the first fluid may be implemented by the conduit 302 of FIGS. 3A-6, the conduit 702 of FIGS. 7-10, and/or the conduit 1102 of FIG. 11.

In some examples, the heat exchange system (e.g., the heat exchange system 300 of FIGS. 3A-6, the heat exchange system 700 of FIGS. 7-10, the heat exchange system 1100 of FIG. 11) includes means for causing the first fluid to exchange thermal energy with a second fluid. For example, the means for causing the first fluid to exchange thermal energy with the second fluid may be implemented by the heat exchanger 304 of FIGS. 3A-11.

In some examples, the heat exchange system (e.g., the heat exchange system 300 of FIGS. 3A-6, the heat exchange system 700 of FIGS. 7-10, the heat exchange system 1100 of FIG. 11) includes means for pulling the first fluid through a first portion of the means for carrying. For example, the means for pulling the first fluid may be implemented by the fan 308, an ejector, a jet-pump, a pump, and/or a pre-sealed vacuum container.

In some examples, the heat exchange system (e.g., the heat exchange system 300 of FIGS. 3A-6, the heat exchange system 700 of FIGS. 7-10, the heat exchange system 1100 of FIG. 11) includes means for adjusting a flow path of the first fluid. For example, the means for adjusting may be implemented by the valve 306 of FIGS. 4-6 and 9, the first valve 704 of FIGS. 7-10, the second valve 706 of FIGS. 7-10, and/or the third valve 708 of FIGS. 7-10.

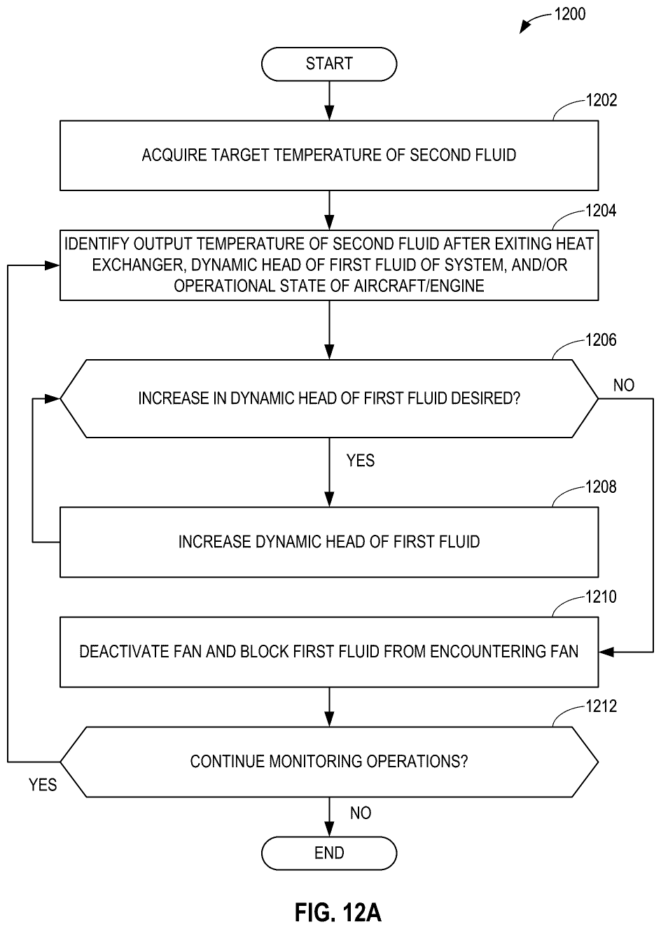

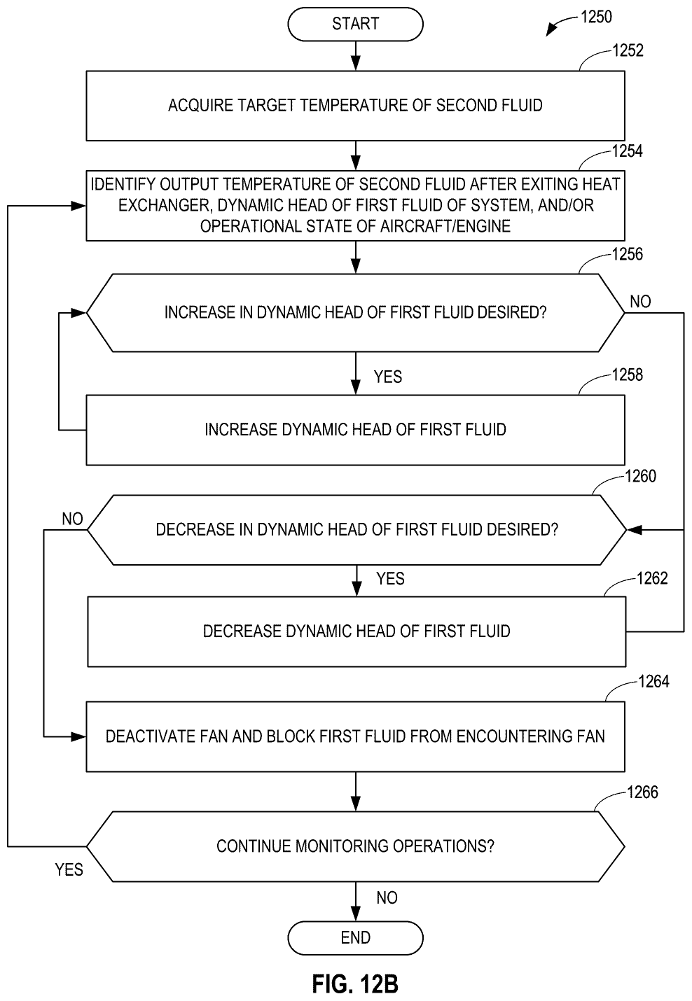

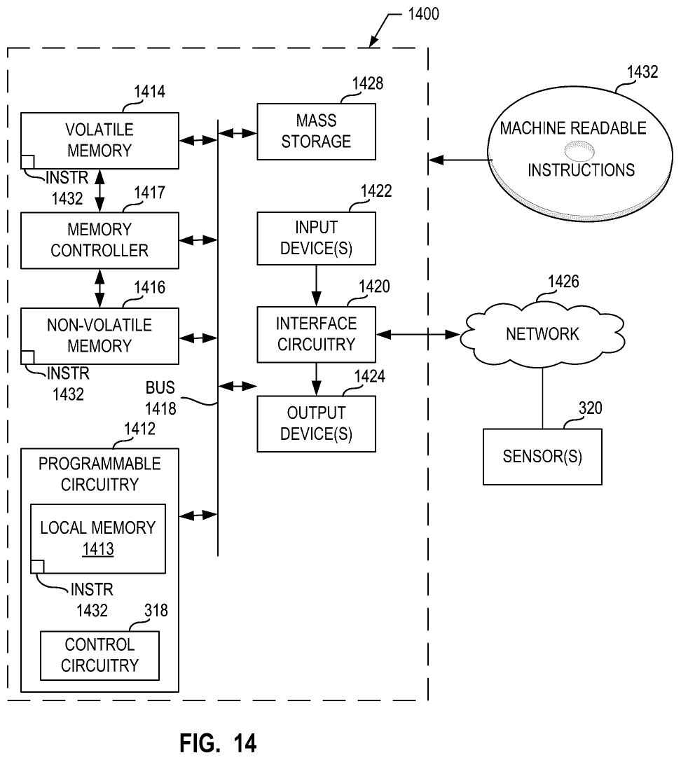

In some examples, the heat exchange system (e.g., the heat exchange system 300 of FIGS. 3A-6, the heat exchange system 700 of FIGS. 7-10, the heat exchange system 1100 of FIG. 11) includes means for controlling the means for adjusting and/or the means for pulling. For example, the means for controlling may be implemented by the control circuitry 318 of FIGS. 4-6 and 8-11. In some examples, the control circuitry 318 may be instantiated by programmable circuitry such as the example programmable circuitry 1412 of FIG. 14. For instance, the control circuitry 318 may be instantiated by a microprocessor executing machine executable instructions such as those implemented by at least blocks 1202, 1204, 1206, 1208, 1210, 1212, 1252, 1254, 1256, 1258, 1260, 1262, 1264, 1266, 1302, 1304, 1306, 1308, 1310, and/or 1312 of FIGS. 12A, 12B, and/or 13. In some examples, the control circuitry 318 may be instantiated by hardware logic circuitry, which may be implemented by an ASIC, XPU, or FPGA circuitry configured and/or structured to perform operations corresponding to the machine readable instructions. Additionally or alternatively, the control circuitry 318 may be instantiated by any other combination of hardware, software, and/or firmware. For example, the control circuitry 318 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example implementation of the control circuitry 318 is illustrated in FIGS. 4-6 and 8-11, one or more of the elements, processes, and/or devices illustrated in and/or discussed in association with FIGS. 4-6 and 8-11 may be combined, divided, re-arranged, omitted, eliminated, and/or implemented in any other way. Further, the control circuitry 318 may be implemented by hardware alone or by hardware in combination with software and/or firmware. Thus, for example, the example control circuitry 318, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example control circuitry 318 of FIGS. 4-6 and 8-11 may include one or more elements, processes, and/or devices in addition to, or instead of, those illustrated in FIGS. 4-6 and 8-11, and/or may include more than one of any or all of the illustrated elements, processes and devices.

Flowcharts representative of example machine readable instructions, which may be executed by programmable circuitry to implement and/or instantiate the control circuitry 318 of FIGS. 4-6 and 8-11 and/or representative of example operations which may be performed by programmable circuitry to implement and/or instantiate the control circuitry 318 of FIGS. 4-6 and 8-11, are shown in FIGS. 12A, 12B, and/or 13. The machine readable instructions may be one or more executable programs or portion(s) of one or more executable programs for execution by programmable circuitry such as the programmable circuitry 1412 shown in the example processor platform 1400 discussed below in connection with FIG. 14 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 12A, 12B, and/or 13, many other methods of implementing the example control circuitry 318 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 12A, 12B, and/or 13 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 12A is a flowchart representative of example machine readable instructions and/or example operations 1200 that may be executed, instantiated, and/or performed by programmable circuitry to ensure that a heat exchange system has a first fluid with sufficient dynamic head to cool a second fluid that supports operations of the aircraft 10 and/or the engine 100 while maintaining an aerodynamic stability of the first fluid flowing through the system and minimizing or otherwise reducing power consumption. The example machine-readable instructions and/or the example operations 1200 of FIG. 12A begin at block 1202, at which the control circuitry 318 acquires a target temperature of a second fluid. For example, the second fluid can be a working fluid (e.g., oil, air, etc.) that supports the operations of the aircraft 10 of FIG. 1 and/or the engine 100 of FIGS. 1-2.

At block 1204, the control circuitry 318 identifies an output temperature of the second fluid exiting the heat exchanger 304 of the heat exchange system 300, 700, 1100, a dynamic head of a first fluid (e.g., air) flowing through the heat exchange system 300, 700, 1100, and/or an operational state of the aircraft 10 and/or the engine 100. For example, the control circuitry 318 can be communicatively coupled to the sensors 320, which can measure a pressure, a temperature, and/or a flow rate of the first fluid and/or the second fluid. Further, the control circuitry 318 can determine the dynamic head of the first fluid based on parameters measured by the sensors 320. In some examples, the control circuitry 318 determines the dynamic head of the first fluid based on operations being performed by the aircraft 10 (FIG. 1) and/or the engine 100 (FIGS. 1-2). For example, the control circuitry 318 can determine the dynamic head of the first fluid is insufficient when the aircraft 10 and/or the engine 100 are performing ground operations. Further, the control circuitry 318 can determine the dynamic head of the first fluid is sufficient when the aircraft 10 and/or the engine 100 are performing cruise operations.

At block 1206, the control circuitry 318 determines whether an increase in the dynamic head of the first fluid is desired. In some examples, the control circuitry 318 determines whether (i) the temperature of the second fluid satisfies (e.g., is less than, is less than or equal to, is within a range of, etc.) the target temperature, (ii) the dynamic head of the first fluid satisfies (e.g., is greater than, is greater than or equal to) a dynamic head threshold, and/or (iii) the operations being performed by the aircraft 10 and/or the engine 100 supply the first fluid with sufficient dynamic head for cooling the second fluid. When (i) the temperature of the second fluid satisfies the target temperature, (ii) the dynamic head of the first fluid satisfies the dynamic head threshold, and/or (iii) the operations being performed by the aircraft 10 and/or the engine 100 are associated with the first fluid having sufficient dynamic head for cooling the second fluid, the operations 1200 proceed to block 1210. Otherwise, when (i) the temperature of the second fluid does not satisfy (e.g., is greater than or equal to, is greater than) the target temperature, (ii) the dynamic head of the first fluid does not satisfy (e.g., is less than, is less than or equal to) the dynamic head threshold, and/or (iii) the operations being performed by the aircraft 10 and/or the engine 100 are associated with the first fluid having insufficient dynamic head for cooling the second fluid, the operations 1200 proceed to block 1208.

At block 1208, the control circuitry 318 increases a dynamic head of the first fluid in the heat exchange system (e.g., the heat exchange system 300 of FIGS. 3A-6, the heat exchange system 700 of FIGS. 7-10, the heat exchange system 1100 of FIG. 11). For example, in the heat exchange system 300 of FIGS. 3A-6 and the heat exchange system 1100 of FIG. 11, the control circuitry 318 can cause the valve 306 (FIGS. 4-6 and 11) to be in (e.g., move to or remain in) the first position 322 (FIGS. 4 and 5) and activate the fan 308 (FIGS. 4-11) (e.g., causes blades of the fan 308 to rotate). In the heat exchange system 700 of FIGS. 7-10, the control circuitry 318 causes the first valve 704 (FIGS. 8-10) to move to an open position 716 (FIG. 9) and activates the fan 308. Additionally, the control circuitry 318 causes the second valve 706 (FIGS. 8-10) and the third valve 708 (FIGS. 8-10) to move to first positions 718 (FIGS. 8 and 9) in which the second valve 706 and the third valve 708 direct the first fluid from the first portion 710 (FIGS. 8-10) of the conduit 702 (FIGS. 7-10) towards the heat exchanger 304 (FIGS. 7-10) and block the first fluid from the second portion 712 (FIGS. 8-10) of the conduit 702 flowing towards the heat exchanger 304. After increasing the dynamic head of the first fluid at block 1208, the operations 1200 return to block 1206.

At block 1210, the control circuitry 318 deactivates the fan 308 and blocks the first fluid from encountering the fan 308. For example, in the heat exchange system 300 of FIGS. 3A-6 and the heat exchange system 1100 of FIG. 11, the control circuitry 318 causes the fan 308 to stop rotating (e.g., stops delivering power to the electric motor 326, deactivates the fan 308) and moves the valve 306 to a second position 328 (FIGS. 4 and 6). In the heat exchange system 700 of FIGS. 7-10, the control circuitry 318 causes the first valve 704 to move to a closed position 722 (FIG. 10) and causes the fan 308 to stop rotating (e.g., stops delivering power to the electric motor 326, deactivates the fan 308). Additionally, the control circuitry 318 causes the second valve 706 and the third valve 708 to move to second positions 724 (FIGS. 8 and 10) in which the second valve 706 and the third valve 708 direct the first fluid from the second portion 712 of the conduit 702 towards the heat exchanger 304.

At block 1212, the control circuitry 318 determines whether to continue monitoring operations. For example, the control circuitry 318 can determine whether to continue monitoring operations based on an operational state of the aircraft 10 and/or the engine 100. In some examples, the control circuitry 318 determines the monitoring operations are complete when the (i) the temperature of the second fluid satisfies the target temperature and/or (ii) the dynamic head of the first fluid satisfies the dynamic head threshold for at least a threshold period of time. When monitoring operations are to continue, the operations 1200 return to block 1204. Otherwise, the operations 1200 terminate.

FIG. 12B is another flowchart representative of example machine readable instructions and/or example operations 1250 that may be executed, instantiated, and/or performed by programmable circuitry to ensure that a heat exchange system has a first fluid with sufficient dynamic head to cool a second fluid that supports operations of the aircraft 10 and/or the engine 100 while preventing the second fluid from being over-cooled (e.g., preventing the second fluid from freezing). The example machine-readable instructions and/or the example operations 1250 of FIG. 12B begin at block 1252, at which the control circuitry 318 acquires a target temperature of a second fluid. For example, the second fluid can be a working fluid (e.g., oil, air, etc.) that supports the operations of the aircraft 10 of FIG. 1 and/or the engine 100 of FIGS. 1-2.

At block 1254, the control circuitry 318 identifies an output temperature of the second fluid exiting the heat exchanger 304 of the heat exchange system 300, 700, 1100, a dynamic head of a first fluid (e.g., air) flowing through the heat exchange system 300, 700, 1100, and/or an operational state of the aircraft 10 and/or the engine 100. For example, the control circuitry 318 can be communicatively coupled to the sensors 320, which can measure a pressure, a temperature, and/or a flow rate of the first fluid and/or the second fluid. Further, the control circuitry 318 can determine the dynamic head of the first fluid based on parameters measured by the sensors 320. In some examples, the control circuitry 318 determines the dynamic head of the first fluid based on operations being performed by the aircraft 10 (FIG. 1) and/or the engine 100 (FIGS. 1-2). For example, the control circuitry 318 can determine the dynamic head of the first fluid is insufficient when the aircraft 10 and/or the engine 100 are performing ground operations. Further, the control circuitry 318 can determine the dynamic head of the first fluid is sufficient when the aircraft 10 and/or the engine 100 are performing cruise operations.

At block 1256, the control circuitry 318 determines whether an increase in the dynamic head of the first fluid is desired. In some examples, the control circuitry 318 determines whether (i) the temperature of the second fluid satisfies (e.g., is less than, is less than or equal to, is within a range of, etc.) a target temperature, (ii) the dynamic head of the first fluid satisfies (e.g., is greater than, is greater than or equal to) a dynamic head threshold, and/or (iii) the operations being performed by the aircraft 10 and/or the engine 100 supply the first fluid with sufficient dynamic head for cooling the second fluid. When (i) the temperature of the second fluid satisfies the target temperature, (ii) the dynamic head of the first fluid satisfies the dynamic head threshold, and/or (iii) the operations being performed by the aircraft 10 and/or the engine 100 are associated with the first fluid having sufficient dynamic head for cooling the second fluid, the operations 1250 proceed to block 1260. Otherwise, when (i) the temperature of the second fluid does not satisfy (e.g., is greater than or equal to, is greater than) the target temperature, (ii) the dynamic head of the first fluid does not satisfy (e.g., is less than, is less than or equal to) the dynamic head threshold, and/or (iii) the operations being performed by the aircraft 10 and/or the engine 100 are associated with the first fluid having insufficient dynamic head for cooling the second fluid, the operations 1250 proceed to block 1258.

At block 1258, the control circuitry 318 increases a dynamic head of the first fluid in the heat exchange system (e.g., the heat exchange system 300 of FIGS. 3A-6, the heat exchange system 700 of FIGS. 7-10, the heat exchange system 1100 of FIG. 11). For example, in the heat exchange system 300 of FIGS. 3A-6 and the heat exchange system 1100 of FIG. 11, the control circuitry 318 can cause the valve 306 (FIGS. 4-6 and 11) to be in (e.g., move to or remain in) the first position 322 (FIGS. 4 and 5) and cause the fan 308 (FIGS. 4-11) to rotate in a first direction (e.g., a rotational direction in which a pitch of the fan blades are designed to pull the first fluid towards the fourth portion 316 of the conduit 302, a direction that increases a flow rate of the first fluid through the heat exchanger 304, clockwise, etc.). In the heat exchange system 700 of FIGS. 7-10, the control circuitry 318 causes the first valve 704 (FIGS. 8-10) to move to an open position 716 (FIG. 9) and causes the fan 308 to rotate in the first direction. Additionally, the control circuitry 318 causes the second valve 706 (FIGS. 8-10) and the third valve 708 (FIGS. 8-10) to move to first positions 718 (FIGS. 8 and 9) in which the second valve 706 and the third valve 708 direct the first fluid from the first portion 710 (FIGS. 8-10) of the conduit 702 (FIGS. 7-10) towards the heat exchanger 304 (FIGS. 7-10) and block the first fluid from the second portion 712 (FIGS. 8-10) of the conduit 702 flowing towards the heat exchanger 304. After increasing the dynamic head of the first fluid at block 1208, the operations 1250 return to block 1256.

At block 1260, the control circuitry 318 determines whether a decrease in the dynamic head of the first fluid is desired. For example, the control circuitry 318 can compare the temperature of the second fluid to a lower temperature threshold, which can be based on a freezing point temperature of the second fluid. That is, the lower temperature threshold can be set a predetermined amount greater than the freezing point temperature of the second fluid to prevent the second fluid from freezing. When the temperature of the second fluid does not satisfy (e.g., is less than, is less than or equal to) the lower temperature threshold, the operations 1250 proceed to block 1262. Otherwise, when the temperature of the second fluid satisfies (e.g., is greater than or equal to, is greater than) the lower temperature threshold, the operations 1250 skip to block 1264.

At block 1262, the control circuitry 318 decreases a dynamic head of the first fluid. For example, the control circuitry 318 can cause the valve 306 to be in (e.g., move to or remain in) the first position 322 and cause the fan 308 to rotate in a second direction opposite the first direction (e.g., a rotational direction in which the pitch of the fan blades creates turbulence, a direction that reduces a flow rate of the first fluid through the heat exchanger 304, counterclockwise, etc.). In the heat exchange system 700 of FIGS. 7-10, the control circuitry 318 causes the fan 308 to rotate in the second direction, causes, the first valve 704 to move to the open position 716, and causes the second valve 706 and the third valve 708 to be in (e.g., move to or remain in) the first positions 718. After decreasing the dynamic head of the first fluid at block 1262, the operations 1250 return to block 1260.

At block 1264, the control circuitry 318 deactivates the fan 308 and blocks the first fluid from encountering the fan 308. For example, in the heat exchange system 300 of FIGS. 3A-6 and the heat exchange system 1100 of FIG. 11, the control circuitry 318 causes the fan 308 to stop rotating (e.g., stops delivering power to the electric motor 326, deactivates the fan 308) and moves the valve 306 to a second position 328 (FIGS. 4 and 6). In the heat exchange system 700 of FIGS. 7-10, the control circuitry 318 causes the first valve 704 to move to a closed position 722 (FIG. 10) and causes the fan 308 to stop rotating (e.g., stops delivering power to the electric motor 326, deactivates the fan 308). Additionally, the control circuitry 318 causes the second valve 706 and the third valve 708 to move to second positions 724 (FIGS. 8 and 10) in which the second valve 706 and the third valve 708 direct the first fluid from the second portion 712 of the conduit 702 towards the heat exchanger 304.

At block 1266, the control circuitry 318 determines whether to continue monitoring operations. For example, the control circuitry 318 can determine whether to continue monitoring operations based on an operational state of the aircraft 10 and/or the engine 100. In some examples, the control circuitry 318 determines the monitoring operations are complete when the (i) the temperature of the second fluid satisfies the target temperature and/or (ii) the dynamic head of the first fluid satisfies the dynamic head threshold for at least a threshold period of time. When monitoring operations are to continue, the operations 1250 return to block 1254. Otherwise, the operations 1250 terminate.

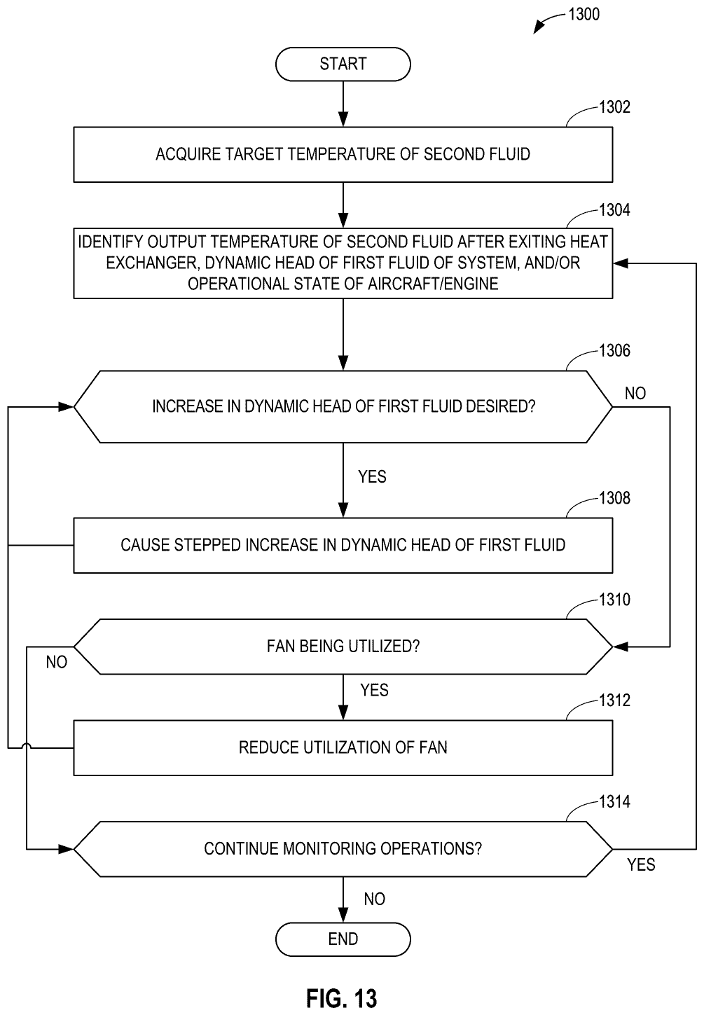

FIG. 13 is a flowchart representative of example machine readable instructions and/or example operations 1300 that may be executed, instantiated, and/or performed by programmable circuitry to ensure that a heat exchange system has a first fluid with sufficient dynamic head to cool a second fluid that supports operations of the aircraft 10 and/or the engine 100 while maintaining an aerodynamic stability of the first fluid flowing through the system and minimizing or otherwise reducing power consumption. The example machine-readable instructions and/or the example operations 1300 of FIG. 13 begin at block 1302, at which the control circuitry 318 acquires a target temperature of a second fluid. For example, the second fluid can be a working fluid (e.g., oil, air, etc.) that supports the operations of the aircraft 10 of FIG. 1 and/or the engine 100 of FIGS. 1-2.

At block 1304, the control circuitry 318 identifies a dynamic head of a first fluid (e.g., air) flowing through the heat exchange system 300, 700, 1100 and/or a temperature of the second fluid after passing through the heat exchanger 304 of the heat exchange system. For example, the control circuitry 318 can be communicatively coupled to the sensors 320, which can measure a pressure, a temperature, and/or a flow rate of the first fluid and/or the second fluid. Further, the control circuitry 318 can determine the dynamic head of the first fluid based on parameters measured by the sensors 320. In some examples, the control circuitry 318 determines the dynamic head of the first fluid based on operations being performed by the aircraft 10 (FIG. 1) and/or the engine 100 (FIGS. 1-2). For example, the control circuitry 318 can determine the dynamic head of the first fluid is insufficient when the aircraft 10 and/or the engine 100 are performing ground operations. Further, the control circuitry 318 can determine the dynamic head of the first fluid is sufficient when the aircraft 10 and/or the engine 100 are performing cruise operations.

At block 1306, the control circuitry 318 determines whether an increase in the dynamic head of the first fluid is desired. In some examples, the control circuitry 318 determines whether (i) the temperature of the second fluid satisfies (e.g., is less than, is less than or equal to, is within a range of, etc.) the target temperature, (ii) the dynamic head of the first fluid satisfies (e.g., is greater than, is greater than or equal to) a dynamic head threshold, and/or (iii) the operations being performed by the aircraft 10 and/or the engine 100 are associated with the first fluid having sufficient dynamic head for cooling the second fluid. When (i) the temperature of the second fluid satisfies the target temperature, (ii) the dynamic head of the first fluid satisfies the dynamic head threshold, and/or (iii) the operations being performed by the aircraft 10 and/or the engine 100 are associated with the first fluid having sufficient dynamic head for cooling the second fluid, the operations 1300 proceed to block 1310. Otherwise, when (i) the temperature of the second fluid does not satisfy (e.g., is greater than or equal to, is greater than) the target temperature, (ii) the dynamic head of the first fluid does not satisfy (e.g., is less than, is less than or equal to) the dynamic head threshold, and/or (iii) the operations being performed by the aircraft 10 and/or the engine 100 are associated with the first fluid having insufficient dynamic head for cooling the second fluid, the operations 1300 proceed to block 1308.

At block 1308, the control circuitry 318 causes a stepped increase in a dynamic head of the first fluid in the heat exchange system (e.g., the heat exchange system 300 of FIGS. 3A-6, the heat exchange system 700 of FIGS. 7-10, the heat exchange system 1100 of FIG. 11). For example, in the heat exchange system 300 of FIGS. 3A-6 and the heat exchange system 1100 of FIG. 11, the control circuitry 318 can cause the valve 306 (FIGS. 4-6 and 11) to move a predetermined amount (e.g., a predetermined rotation, a predetermined distance) towards the first position 322 (e.g., moves the valve 306 to a first modulated position) and causes the fan 308 to rotate at a first modulated speed (e.g., a first speed that is greater than zero and less than a maximum speed). That is, the control circuitry 318 causes a stepped increase in the speed of the fan 308 and an opening into the second portion 312 of the conduit 302. In the heat exchange system 700 of FIGS. 7-10, the control circuitry 318 causes the first valve 704 to move a predetermined amount (e.g., a predetermined rotation, a predetermined distance) towards the open position 716, causes the second valve 706 and the third valve 708 to move towards the first positions 718, and increases an angular velocity of the fan 308. After causing the stepped increase in the dynamic head of the first fluid at block 1308, the operations 1300 return to block 1306.

At block 1310, the control circuitry 318 determines whether the fan 308 is being utilized. For example, when the fan 308 is receiving power and helping drive the flow of the first fluid in the heat exchange system, the control circuitry 318 determines the fan 308 is being utilized. When the fan 308 is being utilized, the operations proceed to block 1312. Otherwise, when the fan 308 is not being utilized, the operations skip to block 1314.

At block 1312, the control circuitry 318 reduces utilization of the fan 308. For example, in the heat exchange system 300 of FIGS. 3A-6 and/or the heat exchange system 1100 of FIG. 11, the control circuitry 318 causes an angular velocity of the fan 308 to be reduced (e.g., by reducing a power associated with the drive signal delivered to the motor 326) and causes the valve 306 to move towards the second position 328. In the heat exchange system 700 of FIG. 7, the control circuitry 318 causes the angular velocity of the fan 308 to be reduced, causes the first valve 704 to move towards the closed position, and causes the second valve 706 and the third valve 708 to move towards the second positions 724. After reducing utilization of the fan 308 at block 1312, the operations 1300 return to block 1306.

At block 1314, the control circuitry 318 determines whether to continue monitoring operations. For example, the control circuitry 318 can determine whether to continue monitoring operations based on an operational state of the aircraft 10 and/or the engine 100. In some examples, the control circuitry 318 determines the monitoring operations are complete when the (i) the temperature of the second fluid satisfies the target temperature and/or (ii) the dynamic head of the first fluid satisfies the dynamic head threshold for at least a threshold period of time. When monitoring operations are to continue, the operations 1300 return to block 1304. Otherwise, the operations 1300 terminate.

FIG. 14 is a block diagram of an example programmable circuitry platform 1400 structured to execute and/or instantiate the example machine-readable instructions and/or the example operations of FIGS. 12A, 12B, and/or 13 to implement the control circuitry 318 of FIGS. 4-6 and 8-11. The programmable circuitry platform 1400 can be, for example, a digital computer, a full authority digital engine control (FADEC) computer or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the control circuitry 318.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, a pressure sensor, a temperature sensor, a flow rate sensor, an altitude sensor, and/or a flight direction sensor.

One or more output devices 1424 are also connected to the interface circuitry 1420 of the illustrated example. The output device(s) 1424 can be implemented, for example, by an actuator and/or drive signal generator circuitry. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1432, which may be implemented by the machine readable instructions of FIGS. 12A, 12B, and/or 13, may be stored in the mass storage device 1428, in the volatile memory 1414, in the non-volatile memory 1416, and/or on at least one non-transitory computer readable storage medium such as a CD or DVD which may be removable.

From the foregoing, it will be appreciated that example systems, apparatus, and methods have been disclosed that ensure that a heat exchange system has a first fluid with sufficient dynamic head to cool a second fluid that supports operations of an aircraft and/or an engine. Additionally, the systems, apparatus, and methods improve a thermal conductivity of the first fluid. Further, the systems, apparatus, and methods maintain an aerodynamic stability of the first fluid flowing through the system and minimize or otherwise reduce a power consumption associated with the heat exchange system.

Further disclosure is provided in the following clauses.

A system comprising a conduit to carry a first fluid, a heat exchanger operatively coupled to the conduit, the heat exchanger to cause the first fluid to exchange thermal energy with a second fluid, a fan positioned in a portion of the conduit to drive the first fluid past the fan, wherein the fan is electrically driven, and a valve coupled to the conduit, wherein the first fluid flows through the portion of the conduit when the valve is in a first position, and wherein the valve blocks the first fluid from flowing through the portion of the conduit when the valve is in a second position.

The system of any preceding clause, wherein the portion of the conduit is a first portion, wherein the first fluid flows through a second portion of the conduit when the valve is in the second position, wherein the first portion of the conduit and the second portion of the conduit intersect downstream of the fan.

The system of any preceding clause, wherein the first portion of the conduit and the second portion of the conduit are defined by branch sections, wherein the branch sections intersect at a third portion of the conduit upstream of the fan and downstream of the heat exchanger.

The system of any preceding clause, further including programmable circuitry to at least one of instantiate or execute machine readable instructions to cause the valve to be in the first position when a temperature of the second fluid after flowing through the heat exchanger does not satisfy a temperature threshold, and cause the valve to be in the second position when the temperature of the second fluid satisfies the temperature threshold.

The system of any preceding clause, wherein the system is associated with an aircraft, further including programmable circuitry to at least one of instantiate or execute machine readable instructions to cause the valve to be in the first position when the aircraft is performing ground operations, and cause the valve to be in the second position when the aircraft is performing cruise operations.

The system of any preceding clause, further including programmable circuitry to at least one of instantiate or execute machine readable instructions to cause the fan to stop rotating when the valve is in the second position.

The system of any preceding clause, wherein the heat exchanger is positioned upstream of the fan.

The system of any preceding clause, wherein the heat exchanger is positioned downstream of the fan.

The system of any preceding clause, further including programmable circuitry to at least one of instantiate or execute machine readable instructions to modulate the valve to a third position between the first position and the second position based on at least one of a flow rate of the first fluid in the conduit, a temperature of the first fluid in the conduit, a target temperature for the second fluid, or an output temperature of the second fluid exiting the heat exchanger.

The system of any preceding clause, further including programmable circuitry to at least one of instantiate or execute machine readable instructions to control a speed of the fan based on at least one of a flow rate of the first fluid in the conduit, a temperature of the first fluid in the conduit, a target temperature for the second fluid, or an output temperature of the second fluid exiting the heat exchanger.

The system of any preceding clause, wherein the system is positioned in a nacelle.

The system of any preceding clause, wherein the system is positioned in a fuselage.

The system of any preceding clause, wherein the first fluid is air and the second fluid is oil.

An aircraft system comprising a conduit to carry a first fluid, the conduit including a first portion and a second portion fluidly in parallel with the first portion, a heat exchanger operatively coupled to the conduit, the heat exchanger to cause the first fluid to exchange thermal energy with a second fluid, and a fan positioned in the first portion of the conduit, wherein a rotation of the fan causes the first fluid to flow past the fan in the first portion of the conduit during first operations, and wherein the first fluid flows in the second portion of the conduit during second operations.

The system of any preceding clause, wherein the first portion of the conduit and the second portion of the conduit merge downstream of the fan.

The system of any preceding clause, further including a valve coupled to the conduit, wherein the first fluid flows through the first portion of the conduit when the valve is in a first position, and wherein the first fluid flows through the second portion of the conduit when the valve is in a second position.

The system of any preceding clause, wherein the valve is in the first position during ground operations, and wherein the valve is in the second position during cruise operations.

The system of any preceding clause, wherein the valve is positioned downstream of the heat exchanger and upstream of the first portion and the second portion of the conduit.

An aircraft system comprising means for carrying a first fluid, the means for carrying including a first portion and a second portion distinct from the first portion, wherein the second portion of the means for carrying is fluidly in parallel with the first portion, means for causing the first fluid to exchange thermal energy with a second fluid, means for pulling the first fluid through a first portion of the means for carrying, and means for directing the first fluid, wherein the means for directing the first fluid directs the first fluid into the first portion of the means for carrying during first operations, and wherein the means directing the first fluid directs the first fluid into the second portion of the means for carrying during second operations distinct from the first operations.

The aircraft system of any preceding clause, wherein the first operations include ground operations for an aircraft associated with the aircraft system, and wherein the second operations include cruise operations for the aircraft.

A method comprising acquiring a target temperature of a second fluid flowing through a heat exchanger coupled to a conduit in an aircraft system, wherein the second fluid exchanges thermal energy with a first fluid in the heat exchanger, when at least one of (i) the temperature of the second fluid satisfies the target temperature, (ii) the dynamic head of the first fluid satisfies the dynamic head threshold, or (iii) the operations being performed by the aircraft or the engine are associated with the first fluid having sufficient dynamic head for cooling the second fluid, at least one of: reducing a rotational velocity of a fan positioned in a first portion of the conduit, or causing a valve to be in or move towards a second position, wherein the first fluid flows through a second portion of the conduit when the valve is in the second position, wherein the second portion of the conduit is distinct from the first portion, and when at least one of (i) the temperature of the second fluid does not satisfy the target temperature, (ii) the dynamic head of the first fluid does not satisfy the dynamic head threshold, or (iii) the operations being performed by the aircraft or the engine are associated with the first fluid having insufficient dynamic head for cooling the second fluid, at least one of: increasing a rotational velocity of the fan, or causing the valve to be in or move towards a first position, wherein the valve blocks the fluid from flowing through the first portion of the conduit when the valve is in the first position.

A method comprising acquiring a target temperature of a second fluid flowing through a heat exchanger coupled to a conduit in an aircraft system, the second fluid to exchange thermal energy with a first fluid in the heat exchanger, identifying at least one of (i) an output temperature of the second fluid after exiting a heat exchanger, (ii) a dynamic head of a first fluid, or (iii) an operational state of an aircraft or an engine, determining whether at least one of (i) the temperature of the second fluid satisfies the target temperature, (ii) the dynamic head of the first fluid satisfies a dynamic head threshold, or (iii) the operations being performed by the aircraft or the engine supply the first fluid with sufficient dynamic head for cooling the second fluid, when at least one of (i) the temperature of the second fluid satisfies the target temperature, (ii) the dynamic head of the first fluid satisfies the dynamic head threshold, or (iii) the operations being performed by the aircraft or the engine are associated with the first fluid having sufficient dynamic head for cooling the second fluid: reducing a rotational velocity of a fan positioned in a first portion of the conduit, and causing a valve to be in or move towards a second position, wherein the first fluid to flow through a second portion of the conduit when the valve is in the second position, wherein the second portion of the conduit is distinct from the first portion, when at least one of (i) the temperature of the second fluid does not satisfy the target temperature, (ii) the dynamic head of the first fluid does not satisfy the dynamic head threshold, or (iii) the operations being performed by the aircraft or the engine are associated with the first fluid having insufficient dynamic head for cooling the second fluid, at least one of increasing a rotational velocity of the fan, or causing the valve to be in or move towards a first position, wherein the valve blocks the fluid from flowing through the first portion of the conduit when the valve is in the first position.

The method of any preceding clause, further including decreasing a dynamic head of the first fluid when the temperature of the second fluid does not satisfy a lower temperature threshold.

The method of any preceding clause, wherein decreasing the dynamic head of the first fluid includes reversing a rotational direction of the fan.

The method of any preceding clause, further including deactivating the fan when the temperature of the second fluid satisfies the target temperature and the lower temperature threshold.

The method of any preceding clause, further including causing the valve to be in the first position when the temperature of the second fluid satisfies the target temperature and the lower temperature threshold.

The method of any preceding clause, further including causing a stepped decrease in a dynamic head of the first fluid when at least one of (i) the temperature of the second fluid does not satisfy the target temperature, (ii) the dynamic head of the first fluid does not satisfy the dynamic head threshold, or (iii) the operations being performed by the aircraft or the engine are associated with the first fluid having insufficient dynamic head for cooling the second fluid.

The method of any preceding clause, wherein causing the stepped increase includes causing at least one of a stepped increase in a speed of the fan or a stepped increase in a cross-sectional area of an opening into the second portion of the conduit.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
a conduit to carry a first fluid;
a heat exchanger operatively coupled to the conduit, the heat exchanger to cause the first fluid to exchange thermal energy with a second fluid;
a fan positioned in a portion of the conduit to drive the first fluid past the fan, wherein the fan is electrically driven; and
a valve coupled to the conduit, wherein the first fluid flows through the portion of the conduit when the valve is in a first position, and wherein the valve blocks the first fluid from flowing through the portion of the conduit when the valve is in a second position.

2. The system of claim 1, wherein the portion of the conduit is a first portion, wherein the first fluid flows through a second portion of the conduit when the valve is in the second position, wherein the first portion of the conduit and the second portion of the conduit intersect downstream of the fan.

3. The system of claim 2, wherein the first portion of the conduit and the second portion of the conduit are defined by branch sections, wherein the branch sections intersect at a third portion of the conduit upstream of the fan and downstream of the heat exchanger.

4. The system of claim 1, further including programmable circuitry to at least one of instantiate or execute machine readable instructions to:
cause the valve to be in the first position when a temperature of the second fluid after flowing through the heat exchanger does not satisfy a temperature threshold; and
cause the valve to be in the second position when the temperature of the second fluid satisfies the temperature threshold.

5. The system of claim 1, wherein the system is associated with an aircraft, further including programmable circuitry to at least one of instantiate or execute machine readable instructions to:
cause the valve to be in the first position when the aircraft is performing ground operations; and
cause the valve to be in the second position when the aircraft is performing cruise operations.

6. The system of claim 1, further including programmable circuitry to at least one of instantiate or execute machine readable instructions to cause the fan to stop rotating when the valve is in the second position.

7. The system of claim 1, wherein the heat exchanger is positioned upstream of the fan.

8. The system of claim 1, wherein the heat exchanger is positioned downstream of the fan.

9. The system of claim 1, further including programmable circuitry to at least one of instantiate or execute machine readable instructions to modulate the valve to a third position between the first position and the second position based on at least one of a flow rate of the first fluid in the conduit, a temperature of the first fluid in the conduit, a target temperature for the second fluid, or an output temperature of the second fluid exiting the heat exchanger.

10. The system of claim 1, further including programmable circuitry to at least one of instantiate or execute machine readable instructions to control a speed of the fan based on at least one of a flow rate of the first fluid in the conduit, a temperature of the first fluid in the conduit, a target temperature for the second fluid, or an output temperature of the second fluid exiting the heat exchanger.

11. The system of claim 1, wherein the system is positioned in a nacelle.

12. The system of claim 1, wherein the system is positioned in a fuselage.

13. The system of claim 1, wherein the first fluid is air and the second fluid is oil.

14. An aircraft system comprising:
a conduit to carry a first fluid, the conduit including a first portion and a second portion fluidly in parallel with the first portion;
a heat exchanger operatively coupled to the conduit, the heat exchanger to cause the first fluid to exchange thermal energy with a second fluid; and
a fan positioned in the first portion of the conduit, wherein a rotation of the fan causes the first fluid to flow past the fan in the first portion of the conduit during first operations, and wherein the first fluid flows in the second portion of the conduit during second operations.

15. The aircraft system of claim 14, wherein the first portion of the conduit and the second portion of the conduit merge downstream of the fan.

16. The aircraft system of claim 14, further including a valve coupled to the conduit, wherein the first fluid flows through the first portion of the conduit when the valve is in a first position, and wherein the first fluid flows through the second portion of the conduit when the valve is in a second position.

17. The aircraft system of claim 16, wherein the valve is in the first position during ground operations, and wherein the valve is in the second position during cruise operations.

18. The aircraft system of claim 16, wherein the valve is positioned downstream of the heat exchanger and upstream of the first portion and the second portion of the conduit.

19. An aircraft system comprising:
means for carrying a first fluid, the means for carrying including a first portion and a second portion distinct from the first portion, wherein the second portion of the means for carrying is fluidly in parallel with the first portion;
means for causing the first fluid to exchange thermal energy with a second fluid;
means for pulling the first fluid through the first portion of the means for carrying; and
means for directing the first fluid, wherein the means for directing the first fluid directs the first fluid into the first portion of the means for carrying during first operations, and wherein the means directing the first fluid directs the first fluid into the second portion of the means for carrying during second operations distinct from the first operations.

20. The aircraft system of claim 19, wherein the first operations include ground operations for an aircraft associated with the aircraft system, and wherein the second operations include cruise operations for the aircraft.
